(19) United States
(12) Patent Application Publication
(10) Pub. No.: US 2004/0236452 A1
(43) Pub. Date: Nov. 25, 2004

(54) Packaging method and apparatus

(76) Inventor: Steven L. Adams, Leander, TX (US)

Correspondence Address: S. Michael Bender, P.O. Box 530399, St. Petersburg, FL, 33747, US

(21) Appl. No.: 10/440,580

(22) Filed: May 19, 2003

(51) Int. Cl. G06F 19/00

(52) U.S. Cl. 700/118

(57) ABSTRACT

A packaging apparatus includes a computer system, a three-dimensional scanner electrically connected to the computer system, and three-dimensional numerically controlled cutting machine electrically connected to the computer system. The three-dimensional scanner provides three-dimensional coordinate data to the computer system of an article that is scanned. The three-dimensional numerically controlled cutting machine, under control of the computer system, operates upon a three-dimensional packing element to form a three-dimensional packing element which is complimentary-shaped with respect to the article that is scanned. Preferably, the three-dimensional scanner includes a laser, three-dimensional scanner. Preferably, the numerically controlled cutting machine operates upon a first packing block for a first half of the article and a second packing block for a second half of the article.

### BACKGROUND OF THE INVENTION

1. Field of the Invention

The present invention relates generally to packing and packaging methods and apparatus, and, more particularly, to methods and apparatus especially adapted for packing and packaging unusually shaped three-dimensional articles.

2. Description of the Prior Art

Packing and packaging square or rectangular three-dimensional articles for shipment is relatively easily accomplished because conventional packaging boxes are generally square or rectangular shaped. For shipping three-dimensional articles that have unusual three-dimensional shapes, such articles are generally placed in a square or rectangular box and are generally packed with packing materials that occupy space in the box between the article and the box. Common packing materials often include a large plurality of relatively small-sized packing elements. The small-sized packing elements are capable of effectively conforming to the unusual shape of the three-dimensional article. However, during shipment of the package, there is a tendency for the small-sized packing elements to shift inside the box. As a result, portions of the article that is shipped may drift inside the box away from surrounding small-sized packing elements resulting in a situation where the article is not be well protected from shock inside the box. In this respect, it would be desirable if packing elements were provided for an unusually shaped three-dimensional article which do not drift inside a shipping box.

In addition to the use of small-sized packing elements described above, throughout the years, a number of additional innovations have been developed relating to packing and packaging methods and apparatus, and the following U.S. patents are representative of some of those innovations: U.S. Pat. Nos. 5,139,151, 5,816,990, 5,957,821, 6,405,095, and 6,446,860.

U.S. Pat. No. 5,139,151 a method for forming large volume foam cushions which are in the form of closed bags. The size of the foam cushions is selected by an operator, and a computer system fills plastic bags in accordance with volume selections made by the system operator. Although this system has the desirable feature of providing a packing element having a selected volume, the shape of the packing element remains essentially the same for each selection made. For an unconventionally shaped article, for a safer and more secure package, it would be desirable if the shape of the packing material in a package were complimentary-shaped to the three-dimensional structure of the unconventionally shaped article.

U.S. Pat. No. 5,816,990 discloses a packaging apparatus that can produce discrete packages that can have different lengths. U.S. Pat. No. 5,957,821 discloses an apparatus for providing a prepackaged product that is packaged on a strip along with the package forming material. U.S. Pat. No. 6,446,860 discloses a package that has a tear away opening. It is noted that each of U.S. Pat. No. 5,816,990, U.S. Pat. No. 5,957,821, and U.S. Pat. No. 6,446,860 discloses a prepackaged article that is prepackaged as part of a manufacturing process. However, with respect to the subject invention herein, it would be desirable to provide form-fitting packing material for an article to be packaged that is not necessarily prepackaged in a manufacturing process that produces a prepackaged article.

With respect to the subject invention herein U.S. Pat. No. 6,405,095 is of special interest for its disclosure of a rapid prototyping and tooling system. This prototyping and tooling system is used to create three-dimensional articles by incrementally adding layer upon layer to form the article. This system employs a computer system which controls scanning, assigning spatial coordinates, and employing a computer-controlled laser beam for heating material in the layers that are formed. In contrast, with respect to the subject invention, it would be desirable to employ a computer system for controlling scanning of a three-dimensional article, assigning spatial coordinates, and employing a computer-controlled, numerically controlled cutting machine to carve out complimentary-shaped forms in packing elements that are complimentary to the three-dimensional article that is scanned.

Still other features would be desirable in a packaging method and apparatus. When articles are shipped, especially articles that have a nonconventional three-dimensional shape, it would be desirable for packing material to form a tight fit around the unconventionally shaped article. Such a tight fit prevents a mutual shifting or translation of the article within a package, such as a box, with respect to the packing material. In this respect, such a tight fit provides less chance of an article from being damaged during shipment.

Thus, while the foregoing body of prior art indicates it to be well known to use packing elements for articles to be shipped in a package, the prior art described above does not teach or suggest a packaging method and apparatus which has the following combination of desirable features: (1) provides packing elements for an unusually shaped three-dimensional article which do not drift inside a shipping box; (2) provides packing materials in a package which are complimentary-shaped to the three-dimensional structure of the unconventionally shaped article being shipped in the package; (3) provides form-fitting packing material for an article to be packaged that is not necessarily prepackaged in a manufacturing process; (4) employs a computer system for controlling scanning of a three-dimensional article, assigning spatial coordinates for the scanned article, and employing a computer-controlled, numerically controlled cutting machine to carve out complimentary-shaped forms in packing elements that are complimentary to the three-dimensional article that is scanned; and (5) provides packing materials that form a tight fit around a unconventionally shaped article. The foregoing desired characteristics are provided by the unique packaging method and apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a packaging apparatus which includes a computer system, a three-dimensional scanner electrically connected to the computer system, and three-dimensional material removal means electrically connected to the computer system. The three-dimensional scanner provides three-dimensional coordinate data to the computer system of an article that is scanned. The three-dimensional material removal means, under control of the computer system, operate upon a three-dimensional packing element to form a three-dimensional packing element which is complimentary-shaped with respect to the article that is scanned.

Preferably, the three-dimensional scanner includes a light-based, three-dimensional scanner. Most preferably, the three-dimensional scanner includes a laser, three-dimensional scanner. Preferably, the three-dimensional material removal means include a numerically controlled cutting machine.

Preferably, the three-dimensional material removal means operate upon a first packing block and a second packing block. The first packing block includes complimentary-shaped surfaces for the outer surfaces of a first half of an article to be packaged, and the second packing block includes complimentary-shaped surfaces for the outer surfaces of a second half of the article to be packaged.

Preferably, a package box is provided for receiving the first packing block, the second packing block, and the article to be packaged. In this respect, the first packing block, the second packing block, and the package box are sized such that when front faces of the respective first packing block and the second packing block are in contact with and in registration with each other, the overall three dimensions of the combined first packing block and second packing block fit tightly in the package box.

In accordance with another aspect of the invention, a method is provided for forming packing elements for a three-dimensional article to be packaged. The method includes the steps of: scanning the three-dimensional article to be packaged with a three-dimensional scanner electrically connected to a computer system; obtaining data in the computer system from the three-dimensional scanner; processing scanning data in the computer system to provide three-dimensional coordinate data; and removing material from the packing elements by a numerically controlled cutting machine, under control of the computer system with employment of the three-dimensional coordinate data to provide complimentary-shaped surfaces in the packing elements which are complimentary to the outer surfaces of the three-dimensional article to be packaged.

The following additional method steps can also be employed: enclosing the article to be packaged with the packing elements that have had material removed therefrom by the numerically controlled cutting machine; and placing the enclosed article and the enclosing packing elements in a container. Preferably, the container forms a tight fit around the enclosed article and the enclosing packing elements.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved packaging method and apparatus which has all of the advantages of the prior art and none of the disadvantages.

It is another object of the present invention to provide a new and improved packaging method and apparatus which may be easily and efficiently manufactured and marketed.

It is a further object of the present invention to provide a new and improved packaging method and apparatus which is of durable and reliable construction.

An even further object of the present invention is to provide a new and improved packaging method and apparatus which is susceptible of a low cost of manufacture with regard to both materials and labor, and which accordingly is then susceptible of low prices of sale to the consuming public, thereby making such packaging method and apparatus available to the buying public.

Still yet a further object of the present invention is to provide a new and improved packaging method and apparatus which provide packing elements for an unusually shaped three-dimensional article which do not drift inside a shipping box.

Still another object of the present invention is to provide a new and improved packaging method and apparatus that provides packing materials in a package which are complimentary-shaped to the three-dimensional structure of the unconventionally shaped article being shipped in the package.

Yet another object of the present invention is to provide a new and improved packaging method and apparatus which provide form-fitting packing material for an article to be packaged that is not necessarily prepackaged in a manufacturing process.

Even another object of the present invention is to provide a new and improved packaging method and apparatus that employs a computer system for controlling scanning of a three-dimensional article, assigning spatial coordinates for the scanned article, and employing a computer-controlled, numerically controlled cutting machine to carve out complimentary-shaped forms in packing elements that are complimentary to the three-dimensional article that is scanned.

Still a further object of the present invention is to provide a new and improved packaging method and apparatus which provide packing materials that form a tight fit around a unconventionally shaped article.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a side view showing an article to be packaged being scanned in three dimensions.

FIG. 2 is a cross-sectional view of a block of packaging material being complimentary-shaped to conform to the three dimensions of the article to be packaged.

FIG. 3 is a block diagram of the major components of the packaging apparatus of the invention.

FIG. 4 is an exploded side view of the article to be packaged being positioned for packaging with packing elements made in accordance with the invention and with a box for receiving the article to be packaged and the packing elements.

### DESCRIPTION OF THE PREFERRED EMBODIMIENT

With reference to the drawings, a new and improved packaging method and apparatus embodying the principles and concepts of the present invention will be described.

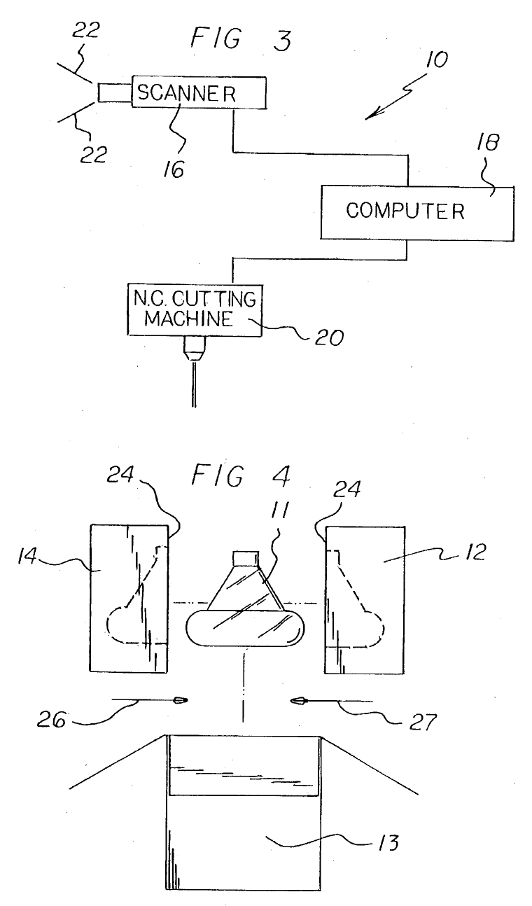

Turning to FIGS. 1-4, there is shown a preferred embodiment of the packaging method and apparatus of the invention generally designated by reference numeral 10. In the preferred embodiment, a packaging apparatus 10 includes a computer system 18, a three-dimensional scanner 16 electrically connected to the computer system 18, and three-dimensional material removal means electrically connected to the computer system 18. The three-dimensional scanner 16 provides three-dimensional coordinate data to the computer system 18 of an article to be packaged that is scanned. The three-dimensional material removal means, under control of the computer system 18, operate upon a three-dimensional packing element to form a three-dimensional packing element which is complimentary-shaped with respect to the article that is scanned.

With the invention, a computer system is provided for controlling scanning of a three-dimensional article, assigning spatial coordinates representing the scanned data of the three-dimensional article, and employing a computer-controlled, numerically controlled cutting machine to carve out complimentary-shaped forms in packing elements that are complimentary to the three-dimensional article that is scanned. The packing elements can be made from inexpensive plastic materials such as are commonly used for packing articles for shipment. As stated above, U.S. Pat. No. 6,405,095 is of special interest for its disclosure of a rapid prototyping and tooling system which includes a computer system which can control scanning of a three-dimensional article, which assigns spatial coordinates relating to data from the scanning, and which employs a computer-controlled output device relating to the spatial coordinates. In these respects, U.S. Pat. No. 6,405,095 is incorporated herein by reference.

Preferably, the three-dimensional scanner 16 includes a light-based, three-dimensional scanner 16. Most preferably, the three-dimensional scanner 16 includes a laser, three-dimensional scanner 16.

The three-dimensional material removal means include a numerically controlled cutting machine 20. The numerically controlled cutting machine 20 can be implemented in a wide variety of ways. For example, the numerically controlled cutting machine 20 can be a milling machine, can be an abrading tool, can be laser based, and can be a heat source, among others.

Preferably, the three-dimensional material removal means operate upon a first packing block 12 and a second packing block 14. The first packing block 12 includes complimentary-shaped surfaces for a first half of an article 11 to be packaged, and the second packing block 14 includes complimentary-shaped surfaces for a second half of the article 11 to be packaged.

A package box 13 is provided for receiving the first packing block 12, the second packing block 14, and the article 11 to be packaged. In this respect, the first packing block 12, the second packing block 14, and the package box 13 are sized such that when front faces 24 of the respective first packing block 12 and the second packing block 14 are in contact with and in registration with each other, the overall three dimensions of the combined first packing block 12 and second packing block 14 fit tightly in the package box 13.

In this respect, preferably, the width of the first packing block 12 is approximately one-half the width of the package box 13, and the width of the 10 second packing block 14 is also approximately one-half the width of the package box 13. Also, the respective heights and lengths of the first packing block 12 and the second packing block 14 are approximately equal to the height and the length of the package box 13.

In accordance with another aspect of the invention, a method is provided for forming packing elements for a three-dimensional article 11 to be packaged. The method includes the steps of: scanning the three-dimensional article 11 to be packaged with a three-dimensional scanner 16 electrically connected to a computer system 18; obtaining data in the computer system 18 from the three-dimensional scanner 16; processing scanning data in the computer system 18 to provide three-dimensional coordinate data; and removing material from the packing elements by a numerically controlled cutting machine 20, under control of the computer system 18 with employment of the three-dimensional coordinate data to provide complimentary-shaped surfaces in the packing elements which are complimentary to the outer surfaces of the three-dimensional article 11 to be packaged.

The following additional method steps can also be employed: enclosing the article 11 to be packaged with the packing elements that have had material removed therefrom by the numerically controlled cutting machine 20; and placing the enclosed article 11 and the enclosing packing elements in a container. Preferably, the container forms a tight fit around the enclosed article 11 and the enclosing packing elements.

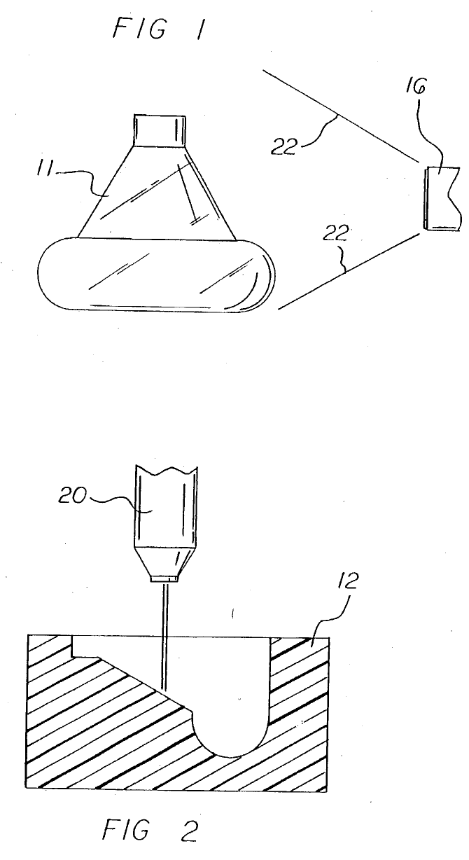

More specifically, to use the apparatus and the method of the invention, as shown in FIG. 1, a unconventionally shaped three-dimensional article 11 is scanned by a three-dimensional scanner 16 using laser beams 22. Inside the computer system 18, the scanning data is converted into three-dimensional coordinate data. Then, using the three-dimensional coordinate data, the numerically controlled cutting machine 20, as shown in FIG. 2, is controlled by the computer system 18 to remove material from a packing element, such as first packing block 12. The surfaces inside the first packing block 12 are complimentary to a first half of the outside surface of the article 11.

The numerically controlled cutting machine 20 is also controlled by the computer system 18 to remove material from the second packing block 14 so that the surfaces inside the second packing block 14 are complimentary to the second half of the outside surface of the article 11.

Once the respective inside surfaces of the first packing block 12 and the second packing block 14 have been formed, the first packing block 12 and the second packing block 14 are ready to be used for enclosing the article 11. As shown in FIG. 4, the first packing block 12 and the second packing block 14 are brought together in the directions shown by directional arrow 26 and directional arrow 27 to enclose the article 11. When the article 11 is fully enclosed by the first packing block 12 and the second packing block 14, the first packing block 12 and the second packing block 14 form a tight fit around the article 11. Also, when the article 11 is fully enclosed by the first packing block 12 and the second packing block 14, the front faces 24 of the first packing block 12 and the second packing block 14 are in contact with each other. Then, the article 11 enclosed by the first packing block 12 and the second packing block 14 is lowered into the package box 13. The first packing block 12 and the second packing block 14 fit tightly inside the package box 13. The package box 13 is then closed and sealed and ready for shipment.

Since the packing elements provide a tight fit around the article 11, and since the package box 13 provides a tight fit around the packing elements, the article 11 will not shift its position and move inside the package box 13 during shipment.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved packaging method and apparatus that is low in cost, relatively simple in design and operation, and which may advantageously be used to provide packing elements for an unusually shaped three-dimensional article which do not drift inside a shipping box. With the invention, a packaging method and apparatus provide packing materials in a package which are complimentary-shaped to the three-dimensional structure of the unconventionally shaped article being shipped in the package. With the invention, a packaging method and apparatus provide form-fitting packing material for an article to be packaged that is not necessarily prepackaged in a manufacturing process. With the invention, a packaging method and apparatus is provided which employs a computer system for controlling scanning of a three-dimensional article, assigning spatial coordinates for the scanned article, and employing a computer-controlled, numerically controlled cutting machine to carve out complimentary-shaped forms in packing elements that are complimentary to the three-dimensional article that is scanned. With the invention, a packaging method and apparatus provide packing materials that form a tight fit around a unconventionally shaped article.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. A packaging apparatus, comprising:
a computer system,
a three-dimensional scanner electrically connected to said computer system, wherein said three-dimensional scanner provides three-dimensional coordinate data to said computer system of an article that is scanned, and
three-dimensional material removal means electrically connected to said computer system, wherein said three-dimensional material removal means, under control of said computer system, operate upon a three-dimensional packing element to form a three-dimensional packing element which is complimentary-shaped with respect to the article that is scanned.

2. The apparatus of claim 1 wherein said three-dimensional scanner includes a light-based, three-dimensional scanner.

3. The apparatus of claim 1 wherein said three-dimensional scanner includes a laser, three-dimensional scanner.

4. The apparatus of claim 1 wherein said three-dimensional material removal means include a numerically controlled cutting machine.

5. The apparatus of claim 1 wherein:
said three-dimensional material removal means operate upon a first packing block and a second packing block,
said first packing block includes complimentary-shaped surfaces for a first half of an article to be packaged, said second packing block includes complimentary-shaped surfaces for a second half of the article to be packaged.

6. The apparatus of claim 5, further including:
a package box for receiving said first packing block, said second packing block, and the article to be packaged.

7. The apparatus of claim 6 wherein said first packing block, said second packing block, and said package box are sized such that when front faces of said respective first packing block and said second packing block are in contact and in registration with each other, the overall three dimensions of the combined first packing block and second packing block fit tightly in said package box.

8. A method for providing packing elements for a three-dimensional article to be packaged, comprising the steps of:
scanning the three-dimensional article to be packaged with a three-dimensional scanner connected to a computer system,
obtaining data in the computer system from the three-dimensional scanner,
processing scanning data in the computer system to provide three-dimensional coordinate data, and
removing material from the packing elements by a numerically controlled cutting machine, under control of the computer system with employment of the three-dimensional coordinate data to provide complimentary-shaped surfaces in the packing elements which are complimentary to the outer surfaces of the three-dimensional article to be packaged.

9. The method of claim 8, further including:
enclosing the article to be packaged with the packing elements that have had material removed therefrom by the numerically controlled cutting machine, and
placing the enclosed article and the enclosing packing elements in a container.

10. The method of claim 9 wherein the container forms a tight fit around the enclosed article and the enclosing packing elements.
